(19) United States
(12) Patent Application Publication
(10) Pub. No.: US 2022/0332471 A1
(43) Pub. Date: Oct. 20, 2022

(54) METHOD FOR MAKING TAMPER RESISTANT CONTAINERS

(71) Applicants: Alexander Yambao, Las Vegas, NV (US); Ashley Yambao, Las Vegas, NV (US); Maria Eleanor P. Yambao, Las Vegas, NV (US); Allen Yambao, Las Vegas, NV (US)

(72) Inventors: Alexander Yambao, Las Vegas, NV (US); Ashley Yambao, Las Vegas, NV (US); Maria Eleanor P. Yambao, Las Vegas, NV (US); Allen Yambao, Las Vegas, NV (US)

(21) Appl. No.: 17/842,269

(22) Filed: Jun. 16, 2022

Related U.S. Application Data
(63) Continuation of application No. 17/199,054, filed on Mar. 11, 2021.

(51) Int. Cl. B65D 33/16; B65D 33/00

(52) U.S. Cl. CPC B65D 33/1691; B65D 33/004; B65D 2401/10; B65D 2203/00

(57) ABSTRACT

A method for making a tamper-resistant container, comprising in a container having a body with a closed lower portion, a middle portion, and a closeable upper portion, punching completely through the material of the container to form a plurality of immediately adjacent perforations in the closable upper portion of the container; printing a two-sided receipt that includes identifying indicia regarding contents stored in the container on one side thereof; applying permanent adhesive to other side thereof; and attaching the receipt to the upper portion of the body by folding the printed receipt in half lengthwise and placing the adhesive covered side over the plurality of adjacent perforations such that the adhesive passes completely through the perforations and the two halves of the receipt stick to each other and to the paper or plastic of the container, thereby permanently sealing the container, wherein pulling upward on the receipt tears the upper portion of the container along the plurality of immediately adjacent perforations, thereby damaging the container and providing visible evidence of tampering with the seal.

### CROSS-REFERENCE TO RELATED APPLICATIONS

This patent application is a continuation of U.S. patent application Ser. No. 17/199,054 filed on Mar. 11, 2021 and entitled “Tamper Resistant Containers for Food and Other Items”, the disclosure of which is hereby incorporated by reference herein in its entirety and made part of the present U.S. utility patent application for all purposes.

### BACKGROUND

The disclosed inventive subject matter relates in general to storage systems, containers, and packages used for food, perishable items, and other items, and more specifically to tamper-resistant storage systems for use with carry-out, pick-up, and delivery services used for food and other items.

Carry-out, pick-up, and delivery systems and services used for food and other items are commonplace in modern society. However, such systems and services necessarily involve multiple individuals handling, packaging, and in some circumstances delivering, the food or other items. Customers and consumers of such systems and services are often understandably concerned about the integrity of the packaging that the food or other items is stored in prior to pick-up or delivery and about the accuracy and contents of an order. A purchase receipt is often attached to or included with food packaging that is picked-up or delivered. However, this receipt may become lost, detached, or otherwise separated from the food packaging. Additionally, the food packaging may be opened, damaged, or otherwise tampered with prior to delivery, resulting in customer concern and/or dissatisfaction. Accordingly, a food packaging system that utilizes or includes tamper-resistant features is highly desirable.

### SUMMARY

The following provides a summary of certain example implementations of the disclosed inventive subject matter. This summary is not an extensive overview and is not intended to identify key or critical aspects or elements of the disclosed inventive subject matter or to delineate its scope. However, it is to be understood that the use of indefinite articles in the language used to describe and claim the disclosed inventive subject matter is not intended in any way to limit the described inventive subject matter. Rather the use of “a” or “an” should be interpreted to mean “at least one” or “one or more”.

One implementation provides a first tamper-resistant storage system comprising a paper or plastic container having a body with a closed lower portion, a middle portion adapted for storing contents, and a closeable upper portion, wherein at least one aperture has been formed in and through the material of the closable upper portion; and an item adapted to cooperate with the closeable open upper portion, wherein the item as adapted to receive identifying indicia regarding the stored contents, wherein the item cooperates with the closeable upper portion to make the closeable upper portion tamper-resistant after closure thereof, wherein the item includes a strip of paper or similar material having adhesive deposited on one side thereof, and wherein when the strip of paper is applied to the closable upper portion, the adhesive passes through the aperture causing the strip of paper to stick to itself, thereby sealing the container. The container may be an envelope, sack, or bag. The at least one aperture may have a predetermined geometry, which may be circular, square, triangular, or numerous other shapes. The item adapted to cooperate with the closeable upper portion of the container may include a centrally placed guideline running lengthwise along the item for facilitating proper positioning of the item on the closeable upper portion of the container. The item adapted to cooperate with the closeable upper portion of the container may be a receipt printed when the contents of the container are initially purchased. The receipt may include an end portion thereof that may be torn off and retained. The adhesive may be a self-adhesive. The adhesive may also be a rubber-based or latex-based adhesive capable of adhering to itself.

Another implementation provides second tamper-resistant storage system, comprising a paper or plastic container having a body with a closed lower portion, a middle portion adapted for storing contents, and a closeable upper portion, wherein a plurality of adjacent apertures have been formed in and through the material of the closable upper portion; and an item adapted to cooperate with the closeable open upper portion, wherein the item is adapted to receive identifying indicia regarding the stored contents, wherein the item cooperates with the closeable upper portion to make the closeable upper portion tamper-resistant after closure thereof, wherein the item includes a strip of paper or similar material having adhesive deposited on one side thereof, and wherein when the strip of paper is applied to the closable upper portion by folding the strip over onto itself, the adhesive passes through each aperture in the plurality of adjacent apertures causing the strip of paper to stick to itself, thereby sealing the container. The container may be an envelope, sack, or bag. The at least one aperture may have a predetermined geometry, which may be circular, square, triangular, or numerous other shapes. The item adapted to cooperate with the closeable upper portion of the container may include a centrally placed guideline running lengthwise along the item for facilitating proper positioning of the item on the closeable upper portion of the container. The item adapted to cooperate with the closeable upper portion of the container may be a receipt printed when the contents of the container are initially purchased. The receipt may include an end portion thereof that may be torn off and retained. The adhesive may be a self-adhesive. The adhesive may also be a rubber-based or latex-based adhesive capable of adhering to itself.

Still another implementation provides a third tamper-resistant storage system, comprising a paper or plastic container having a body with a closed lower portion, a middle portion adapted for storing contents, and a closeable upper portion, wherein a plurality of immediately adjacent circular apertures have been formed in and through the material of the closable upper portion; and an item adapted to cooperate with the closeable open upper portion, wherein the item includes identifying indicia regarding the stored contents, wherein the item cooperates with the closeable upper portion to make the closeable upper portion tamper-resistant after closure thereof, wherein the item includes a strip of paper or similar material having adhesive deposited on one side thereof, and wherein when the strip of paper is applied to the closable upper portion by folding the adhesive-bearing side of the strip over onto itself, the adhesive passes through each aperture in the plurality of immediately adjacent apertures causing the strip of paper to stick to itself, thereby sealing the container in a tamper-resistant manner. The container may be an envelope, sack, or bag. The item adapted to cooperate with the closeable upper portion of the container may be a receipt printed when the contents of the container are initially purchased. The receipt may include an end portion thereof that may be torn off and retained. The adhesive may be a self-adhesive. The adhesive may also be a rubber-based or latex-based adhesive capable of adhering to itself. The body of the container may further include additional information regarding the contents of the bag or the source of the contents of the bag printed thereof.

Yet another implementation provides a method for making a tamper-resistant container, comprising in a paper or plastic container having a body with a closed lower portion, a middle portion adapted for storing contents, and a closeable upper portion, punching completely through the paper or plastic to form a plurality of immediately adjacent perforations in the closable upper portion of the container; printing a two-sided receipt that includes identifying indicia regarding the contents stored in the container on one side thereof; applying permanent adhesive to the side of the printed receipt opposite the side that includes identifying indicia regarding the contents stored in the container; and attaching the receipt to the closable upper portion of the body by folding the printed receipt in half lengthwise and placing the adhesive covered side of the receipt over the plurality of adjacent perforations such that the adhesive passes completely through the perforations and the two halves of the receipt stick to each other and to the paper or plastic, thereby sealing the container in a permanent manner, wherein pulling upward on the receipt tears the upper portion of the container along the plurality of immediately adjacent perforations, thereby damaging the container and providing visible evidence of tampering with the seal. The container may be an envelope, sack, or bag. The apertures may have a predetermined geometry and the predetermined geometry may be circular, square, or triangular. The method may further comprise providing a centrally placed guideline running lengthwise along the adhesive side of the receipt item for facilitating proper positioning of the receipt on the closeable upper portion of the container. The method may further comprise attaching the receipt to the closable upper portion of the body in a manner that leaves a slight overhang that is used to pull the receipt in an upward direction such that the perforated upper portion tears neatly in a linear manner to unseal the container. The method may further comprise making the overhanging portion of the receipt detachable such that the overhanging portion may be removed. The method may further comprise using a self-adhesive for the adhesive, or a rubber-based or latex-based adhesive capable of adhering to itself for the adhesive. The method may further comprise printing additional information regarding the contents of the bag or the source of the contents of the bag on the body of the container.

It should be appreciated that all combinations of the foregoing concepts and additional concepts discussed in greater detail below (provided such concepts are not mutually inconsistent) are contemplated as being part of the inventive subject matter disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1A depicts a first example implementation of the disclosed tamper-resistant containers, wherein the container is an envelope shown in an unsealed configuration;

FIG. 1B depicts the example implementation of FIG. 1A in a sealed configuration with a portion of the paper receipt component being visible on the exterior of the tamper-resistance container;

FIG. 2A depicts a second example implementation of the disclosed tamper-resistant containers, wherein the container is a paper bag shown in an open configuration;

FIG. 2B depicts the example implementation of FIG. 2A shown in a closed or sealed configuration, wherein the paper receipt component has been used as a closure device;

FIG. 3A depicts a third example implementation of the disclosed tamper-resistant containers, wherein the container is a paper bag shown in an open configuration and an adhesive-bearing paper receipt component is shown prior to placement around the upper portion of the bag;

FIG. 3B depicts the example implementation of FIG. 3A shown in a closed or sealed configuration, wherein the paper receipt component has been used as a closure device; and

FIG. 3C depicts the example implementation of FIG. 3B, wherein the paper receipt component has been partially torn off the upper portion of the bag to unseal the container and allow access to the contents thereof.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed inventive subject matter. Accordingly, the following implementations are set forth without any loss of generality to, and without imposing limitations upon, the claimed subject matter.

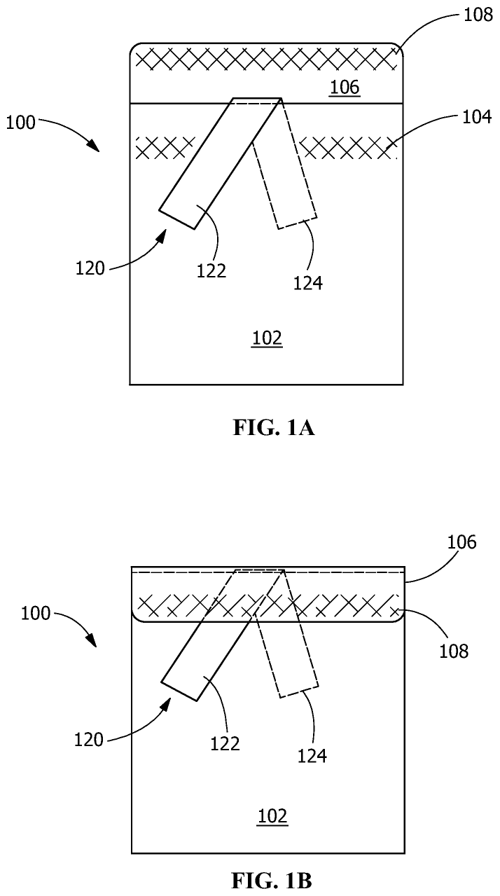

FIG. 1A depicts a first example implementation of the disclosed tamper-resistant containers, wherein the container is an envelope shown in an unsealed configuration and FIG. 1B depicts the example implementation of FIG. 1A in a sealed configuration with a portion of the paper receipt component being visible on the exterior of the tamper-resistance container. In FIGS. 1A-1B, tamper-resistance container 100 includes an envelope, sack, or bag component 102 and a receipt component 120. Envelope, sack, or bag component 102 includes closed lower portion 104, middle portion 106, which accommodates various items for storage, and closeable upper portion 110. Adhesive 108 may be deposited on the upper area of middle portion 106 and adhesive 112 may be deposited on closeable upper portion 110. The adhesive allows container 100 to be sealed in a closed configuration simply by folding upper portion 110 onto middle portion 106 and applying pressure. In this implementation, receipt component 120 does not include adhesive, but rather is folded at a predetermined angle and inserted into container 100 prior to the closure and sealing thereof. Exterior portion 122, which includes identifying indicia (e.g., order contents, name of person ordering, delivery address, etc.) remains on the outside of container 100 while interior portion 124 remains within middle portion 106 after closure and sealing. In this manner, receipt component 120 cannot be removed or replaced without damaging the receipt itself or re-opening the sealed container, either of which would provide evidence of tampering to the customer. Various adhesives may be used with this example implementation including latex or rubber based adhesives or any other glue or adhesive material, including self-sealing materials, suitable for use with the disclosed tamper resistant containers.

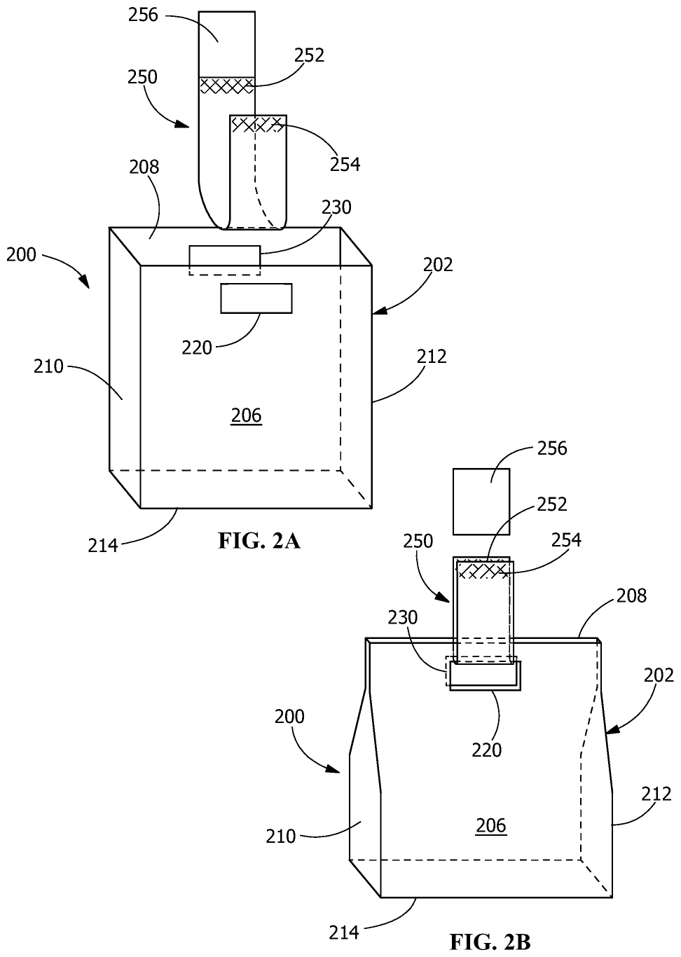

FIG. 2A depicts a second example implementation of the disclosed tamper-resistant containers, wherein the container is a paper (or plastic) bag shown in an open configuration; and FIG. 2B depicts the example implementation of FIG. 2A shown in a closed or sealed configuration, wherein the paper receipt component has been used as a closure device. In FIGS. 2A-2B, tamper-resistant container 200 includes bag component 202 and receipt component 250. Bag component 202 includes closed bottom portion 204, middle portion 206, which accommodates various items for storage, front panel 208 in which first slot 210 is formed, rear panel 212, in which second slot 214 is formed, first side panel 216, and second side panel 218. Receipt component 250 includes first adhesive end 252 and second adhesive end 254, which are joined together when receipt component 250 is looped through first slot 210 and second slot 214 to form a closure device. When closed in this manner, container 200 cannot be re-opened without removing the receipt component, and receipt component 250 cannot be removed or replaced without damaging the receipt itself, which would provide evidence of tampering to the customer. Various adhesives may be used with this example implementation including latex or rubber based adhesives or any other glue or adhesive material, including self-sealing materials, suitable for use with the disclosed tamper resistant containers. Receipt component 250 may also include a detachable portion 256 that may be removed from the longer portion of receipt component 250 if the user of the container wishes to retain information printed thereon.

In another implementation, the disclosed tamper-resistant container is a plastic or paper bag or similar item that includes a row of apertures or holes formed in or near the upper, open edges thereof. These apertures or holes may be formed using a specialized manual or automated punch or other item capable of punching completely through the material of the bag. The apertures may be formed in the bag prior to the use of the bag (e.g., at the time the bag is manufactured) or the apertures may be formed at the point of purchase by a cashier or other person by using the described punch. The apertures may be any of a variety of shapes including circular, oval, square, rectangular, triangular, and trapezoidal. The bag is sealed with a receipt that is typically generated at the time the items placed within the bag are purchased. The receipt may be standard paper or a thermal type printable paper that further includes an adhesive that is applied directly onto one side of the receipt. The receipt may be provided in roll form or in other commonly used forms. The adhesive may be self-adhesive or a rubber or latex type adhesive that permanently seals the receipt to the material of bag and to the material of the receipt itself. After the items have been placed in the bag, the adhesive-bearing side of the receipt is placed over and across the apertures or holes, either in a horizontal or vertical orientation, such that the adhesive sticks to itself though the apertures or holes, as well as sticking directly to the material of the bag. By sealing the top edges of the bag in this manner, the sealed bag cannot be re-opened without damaging both the receipt and the material of the bag itself, making any tampering clearly apparent.

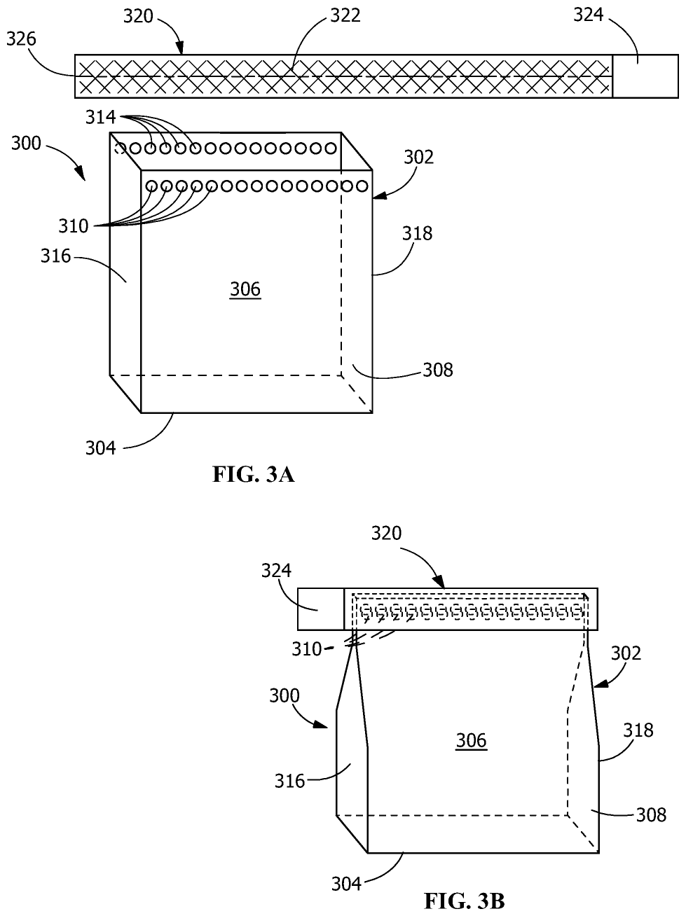

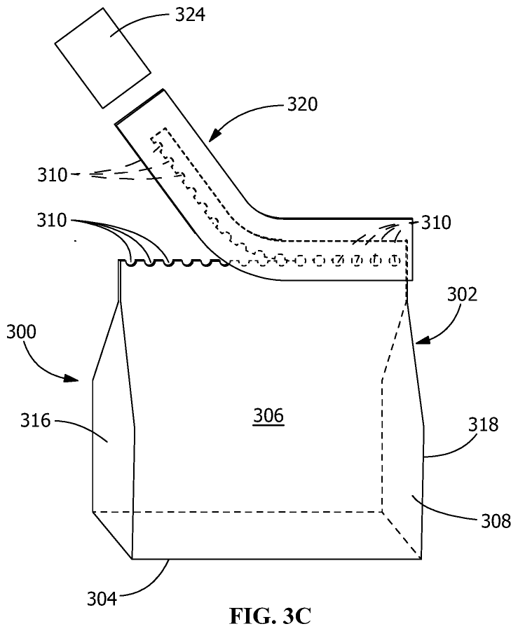

FIG. 3A depicts a third example implementation of the disclosed tamper-resistant containers, wherein the container is a paper bag shown in an open configuration and an adhesive-bearing paper receipt component is shown prior to placement around the upper portion of the bag. FIG. 3B depicts the example implementation of FIG. 3A shown in a closed or sealed configuration, wherein the paper receipt component has been used as a closure device; and FIG. 3C depicts the example implementation of FIG. 3B, wherein the paper receipt component has been partially torn off the upper portion of the bag to unseal the container and allow access to the contents thereof. In FIGS. 3A-3C, tamper-resistant storage system 300 includes bag component 302 and receipt component 320. Bag component 302 includes closed bottom portion 304, middle portion 306, which accommodates various items for storage, front panel 308 in which apertures 310 are formed, rear panel 312, in which apertures 314 are formed in horizontal alignment with apertures 310, first side panel 316, and second side panel 318. Receipt component 320 includes adhesive 322 deposited on one side thereof. In FIGS. 3A-3C, apertures 310 and 314 are circular in shape and have been formed immediately adjacent to one another to create a perforation along the upper edge of bag component 302. Receipt component 320 includes adhesive deposited along the length of one side thereof and is long enough to fold completely in half and onto itself as shown in FIG. 3B, while leaving a slight overhang (see left side of 320). This overhang may be grasped and used to pull receipt component 320 upward such that the perforated top edge of bag component 302 tears neatly in a linear manner (see FIG. 3C) to unseal bag component 302. Receipt component 320 cannot be removed from bag component 302 without damaging the upper portion of the bag component, thereby making any tampering with the seal visible. Receipt component 320 may also include detachable portion 324 that may be removed from the longer portion of receipt component 320 if the user of the container wishes to retain information printed thereon. Additionally, as shown in FIG. 3A, receipt component 320 may include centrally located guideline 322 running lengthwise along receipt component 320 for facilitating proper positioning of receipt component 320 on the closeable upper portion of container.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed inventive subject matter. Various functions and elements described herein may be partitioned differently from those shown without departing from the scope of the disclosed inventive subject matter. Generic principles defined herein may be applied to other implementations. Different numbers of a given module or unit may be employed, a different type or types of a given module or unit may be employed, a given module or unit may be added, or a given module or unit may be omitted.

It should be appreciated that all combinations of the foregoing concepts and additional concepts discussed in greater detail herein (provided such concepts are not mutually inconsistent) are contemplated as being part of the disclosed inventive subject matter. All combinations of claimed subject matter appearing at the end of this disclosure are contemplated as being part of the inventive subject matter disclosed herein. While the disclosed inventive subject matter has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed inventive subject matter in its broader aspects is not limited to any of the specific details, representative devices and methods, and/or illustrative examples shown and described. Accordingly, departures may be made from such details without departing from the spirit or scope of the general inventive concept.

What is claimed:

1. A method for making a tamper-resistant container, comprising:
(a) in a paper or plastic container having a body with a closed lower portion, a middle portion adapted for storing contents, and a closeable upper portion, punching completely through the paper or plastic to form a plurality of immediately adjacent perforations in the closable upper portion of the container;
(b) printing a two-sided receipt that includes identifying indicia regarding the contents stored in the container on one side thereof;
(c) applying permanent adhesive to the side of the printed receipt opposite the side that includes identifying indicia regarding the contents stored in the container; and
(d) attaching the receipt to the closable upper portion of the body by folding the printed receipt in half lengthwise and placing the adhesive covered side of the receipt over the plurality of adjacent perforations such that the adhesive passes completely through the perforations and the two halves of the receipt stick to each other and to the paper or plastic, thereby sealing the container in a permanent manner,
(e) wherein pulling upward on the receipt tears the upper portion of the container along the plurality of immediately adjacent perforations, thereby damaging the container and providing visible evidence of tampering with the seal.

2. The method of claim 1, wherein the container is an envelope, sack, or bag.

3. The method of claim 1, wherein the apertures have a predetermined geometry, and wherein the predetermined geometry is circular, square, or triangular.

4. The method of claim 1, further comprising providing a centrally placed guideline running lengthwise along the adhesive side of the receipt item for facilitating proper positioning of the receipt on the closeable upper portion of the container.

5. The method of claim 1, further comprising attaching the receipt to the closable upper portion of the body in a manner that leaves a slight overhang that is used to pull the receipt in an upward direction such that the perforated upper portion tears neatly in a linear manner to unseal the container.

6. The method of claim 5, further comprising making the overhanging portion of the receipt detachable such that the overhanging portion may be removed.

7. The method of claim 1, further comprising using a self-adhesive for the adhesive.

8. The method of claim 1, further comprising using a rubber-based or latex-based adhesive capable of adhering to itself for the adhesive.

9. The method of claim 1, further comprising printing additional information regarding the contents of the bag or the source of the contents of the bag on the body of the container.

10. A method for making a tamper-resistant container, comprising:
(a) in a paper or plastic container having a body with a closed lower portion, a middle portion adapted for storing contents, and a closeable upper portion, punching completely through the paper or plastic to form a plurality of immediately adjacent perforations, each having a predetermined geometry, in the closable upper portion of the container;
(b) printing a two-sided receipt that includes identifying indicia regarding the contents stored in the container on one side thereof;
(c) providing a centrally placed guideline running lengthwise along the side of the printed receipt opposite the side that includes identifying indicia regarding the contents stored in the container;
(d) applying permanent adhesive to the side of the printed receipt that includes the centrally placed guideline; and
(e) using the centrally placed guideline for proper positioning and attaching the receipt to the closable upper portion of the body by folding the printed receipt in half lengthwise and placing the adhesive covered side of the receipt over the plurality of adjacent perforations such that the adhesive passes completely through the perforations and the two halves of the receipt stick to each other and to the paper or plastic, thereby sealing the container in a permanent manner,
(f) wherein pulling upward on the receipt tears the upper portion of the container along the plurality of immediately adjacent perforations, thereby damaging the container and providing visible evidence of tampering with the seal.

11. The method of claim 10, wherein the container is an envelope, sack, or bag.

12. The method of claim 10, wherein the predetermined geometry is circular, square, or triangular.

13. The method of claim 1, further comprising attaching the receipt to the closable upper portion of the body in a manner that leaves a slight overhang that is used to pull the receipt in an upward direction such that the perforated upper portion tears neatly in a linear manner to unseal the container.

14. The method of claim 13, further comprising making the overhanging portion of the receipt detachable such that the overhanging portion may be removed.

15. The method of claim 13, further comprising using a self-adhesive for the adhesive.

16. The method of claim 10, further comprising using a rubber-based or latex-based adhesive capable of adhering to itself for the adhesive.

17. A method for making a tamper-resistant container, comprising:
(a) in a paper or plastic container having a body with a closed lower portion, a middle portion adapted for storing contents, and a closeable upper portion, punching completely through the paper or plastic to form a plurality of immediately adjacent perforations in the closable upper portion of the container;
(b) printing a two-sided receipt that includes identifying indicia regarding the contents stored in the container on one side thereof;
(c) applying permanent adhesive to the side of the printed receipt opposite the side that includes identifying indicia regarding the contents stored in the container, wherein the adhesive is a self-adhesive, or a rubber-based adhesive or a latex-based adhesive capable of adhering to itself; and
(d) attaching the receipt to the closable upper portion of the body by folding the printed receipt in half lengthwise and placing the adhesive covered side of the receipt over the plurality of adjacent perforations such that the adhesive passes completely through the perforations and the two halves of the receipt stick to each other and to the paper or plastic, thereby sealing the container in a permanent manner,
(e) wherein pulling upward on the receipt tears the upper portion of the container along the plurality of immediately adjacent perforations, thereby damaging the container and providing visible evidence of tampering with the seal.

18. The method of claim 17, wherein the container is an envelope, sack, or bag, and wherein the apertures have a predetermined geometry that is is circular, square, or triangular.

19. The method of claim 17, further comprising providing a centrally placed guideline running lengthwise along the adhesive side of the receipt item for facilitating proper positioning of the receipt on the closeable upper portion of the container.

20. The method of claim 17, further comprising attaching the receipt to the closable upper portion of the body in a manner that leaves a slight overhang that is used to pull the receipt in an upward direction such that the perforated upper portion tears neatly in a linear manner to unseal the container, and wherein the overhanging portion of the receipt is detachable such that the overhanging portion may be removed.
